(19) United States
(12) Patent Application Publication
(10) Pub. No.: US 2009/0210882 A1
(43) Pub. Date: Aug. 20, 2009

(54) SYSTEM AND METHODS FOR ASYNCHRONOUSLY UPDATING INTERDEPENDENT TASKS PROVIDED BY DISPARATE APPLICATIONS IN A MULTI-TASK ENVIRONMENT

(75) Inventors: Shikha Srivastava, Cary, NC (US); Niraj Dincsh Patel, Apex, NC (US); Samar Choudhary, Morrisville, NC (US); Vijay Pandiarajan, Apex, NC (US); Richard King, Cary, NC (US)

Correspondence Address: AKERMAN SENTERFITT, P.O. BOX 3188, WEST PALM BEACH, FL, 33402-3188, US

(73) Assignee: INTERNATIONAL BUSINESS MACHINES CORPORATION, Armonk, NY (US)

(21) Appl. No.: 12/032,961

(22) Filed: Feb. 18, 2008

(51) Int. Cl. G06F 9/46

(52) U.S. Cl. 718/107

(57) ABSTRACT

A computer-based system for updating interdependent tasks in a multi-task environment is provided. The system includes one or more processors for processing processor-executable code and an input/output interface communicatively linked to at least one processor. The system further includes a brokering module configured to execute on the at least one processor. The brokering module can be configured to interconnect a plurality of event-responsive interdependent tasks in response to an event generated while one of the tasks is being processed. Different tasks can be provided by different applications. The brokering module is configured to initiate an asynchronous updating of the tasks, wherein the asynchronous updating comprises a background process of the multi-task environment preformed for each task not being currently processed and wherein the updating is performed while the one task is being processed. The brokering module, moreover, is further configured to provide through the interface a status notification of the updating of each of the tasks.

### FIELD OF THE INVENTION

The present invention is related to the field of software applications, and more particularly, to updating software application tasks in a multi-task environment.

### BACKGROUND OF THE INVENTION

A task is typically a distinct portion of an application program comprising instructions that are executed by one or more processors of a computing device. In a typical multi-task environment multiple tasks can be performed, with apparent if not actual simultaneity, by a single processor of the computing device. The different tasks can be provided by multiple, independent software applications, none of which need be aware of each other prior to an event trigger. For example, with a user interface such as a Web-based administration console the supports a multi-task environment, a user can open multiple tasks, typically represented by tabs, and work on multiple interdependent tasks in parallel. The different tasks can be provided from applications running on different Web sites.

In certain situations, a user, while working through a currently-open task, may implicitly or explicitly initiate the update of other interdependent tasks based on an event trigger in the current task. A system administrator, for example, may need to configure applications on different servers, check a backend database status, analyze current system problems and perform other tasks at various network sites. Typically, the system administrator must launch each distinct task one at time and key-in the particular site locations to configure or access data pertaining to the different sites. Such an approach, however, can be cumbersome as well as time consuming.

Thus, although multi-task environments are now rather common place, there are no effective and efficient mechanisms or techniques for passing a message, task context or other data to multiple tasks. Nor are there effective and efficient mechanisms for loading multiple tasks asynchronously or for providing user indications of the status of the multiple tasks.

### SUMMARY OF THE INVENTION

The present invention is directed to systems, computer products, and related methods for asynchronously updating interdependent tasks in a multi-task environment. The interdependent tasks can be provided by disparate applications. The systems, computer products, and related methods also can provide notifications of the status of the interdependent tasks.

One embodiment is a computer-based system for updating interdependent tasks in a multi-task environment. The system can include one or more processors for processing processor-executable code. The system also can include an input/output interface communicatively linked to at least one processor. The system further can include a brokering module configured to execute on at least one processor. More particularly, the brokering module can be configured to interconnect a plurality of event-responsive interdependent tasks in response to an event generated while one of the tasks is being processed, the tasks being provided by different applications. The brokering module also can be configured to initiate an asynchronous updating of the tasks, the asynchronous updating comprising a background process of the multi-task environment preformed for each task not being currently processed and the updating being performed while the one task is being processed. The broker module further can through the interface a status notification of the updating of each of the tasks.

Another embodiment is a computer-implemented method for updating interdependent tasks in a multi-task environment. The method can include interconnecting a plurality of event-responsive interdependent tasks in response to an event generated while one of the tasks is being processed, wherein the tasks are provided by different applications. The method also can include initiating an asynchronous updating of the tasks, wherein the asynchronous updating comprises a background process of the multi-task environment preformed for each task not being currently processed and wherein the updating is performed while the one task is being processed. Additionally, the method can include providing a status notification of the updating of each of the tasks.

Yet another embodiment is a computer product, such an optical media disk, having computer code embedded therein. The computer code can be configured to cause a computer, when loaded on the computer, to perform the procedures and functions of the above-described method.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic view of a system for updating interdependent tasks in a multi-task environment, according to one embodiment.

FIG. 2 is a schematic view of certain operative features of the system illustrated in FIG. 1.

FIG. 3 is a flowchart of exemplary steps in a method for c updating interdependent tasks in a multi-task environment, according to another embodiment.

### DETAILED DESCRIPTION

The computer-based systems and methods described herein allow update information to be passed to multiple tasks within a multi-task environment. The update information, more particularly, can include a message, task context (data used by the task that is saved, at least temporarily in memory, to allow a task interruption and subsequent continuation of the task from the point of interruption), and/or other data for updating a task. The tasks can include an open task, a closed task, and/or html fragment. Moreover, a task or html fragment can be updated by the systems or according to the methods described herein through background processing. Unloaded tasks can be loaded and subsequently updated, or, alternatively, be first updated and then loaded. The updating of tasks can be triggered, or initiated, in response to a detected event, which can be a user-initiated event, such as a mouse click, or an event resulting from a machine or process interaction. Thus, as used here, an event trigger includes a user, machine, or process interaction that leads to a corresponding action or event at any target to which the event is passed. Likewise, an event is passed when sent to one or more targets.

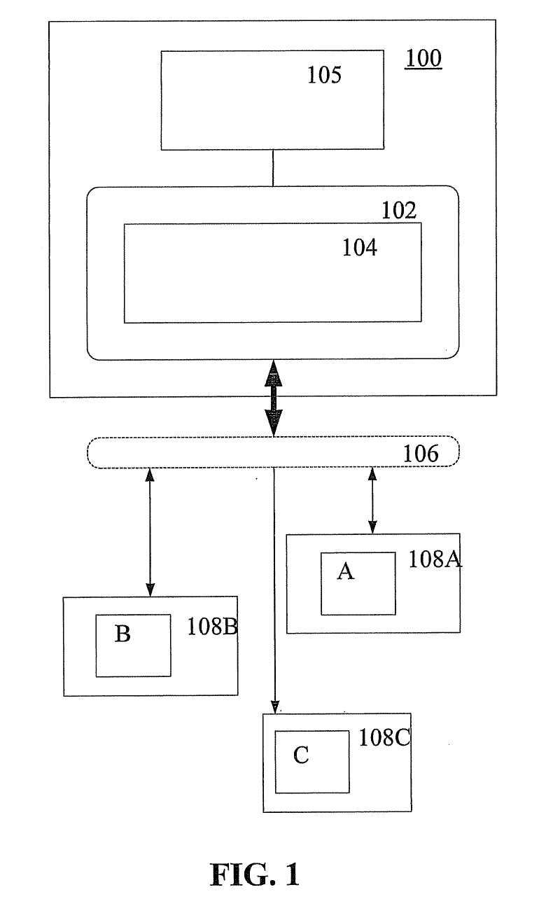

FIG. 1 is a schematic view of a computer-based system 100 for updating interdependent tasks in a multi-task environment. The system 100 illustratively comprises one or more logic-based processors 102 comprising registers (not explicitly shown), logic gates (also not shown explicitly shown), and other logic-based circuitry for processing executable code. Additionally, the system illustratively includes a brokering module 104. The system also include an input/output (I/O) 105. The brokering module 104 can be implemented in processor-executable code configured to execute on the one or more processors 102 for performing the processes and functions described herein. Alternatively, however, the brokering module 104 can be implemented in dedicated hardwired circuitry for carrying out the same processes and functions. In still another embodiment, the brokering module 104 can be implemented in a combination of executable code and hardwired circuitry.

Optionally, the system 100 further includes an interface 106 communicatively linked to the one or more processors 102. Through the interface 106, the system 100 can access multiple interdependent tasks A, B, C contained, respectively, in a plurality of applications 108A, 108B, 108C, None of the applications nor the respective tasks provided by each need have a priori knowledge about the others. Thus, the tasks A, B, C are illustratively provided by different independent applications 108A, 108B, 108C. One or more of the tasks A, B, C can be an event-responsive task configured to respond to an event, such as a user-initiated event (e.g., mouse click) or other interaction involving a machine or process. The applications 108A, 108B, 108C need not be programmed to be aware of one another, but, as described more particularly below, can be made aware through the brokering mechanism effected with the brokering module 104.

Operatively, the brokering module 104 acts as a broker or mediator to interconnect the interdependent tasks A, B, C in response to an event generated while one of the tasks is being processed by the processor 102. The brokering module 104 is further configured to initiate an asynchronous updating of the tasks A, B, C. The asynchronous updating, more particularly, is a background process of the multi-task environment of the system 100 and is preformed for each task not being currently processed and wherein the updating is performed while the one task is being processed. The brokering module 104 also is the mediator that can provide through the I/O interface 105 a status notification of the updating of each of the tasks. Status notifications can indicate to the user the processing status pertaining to the different tasks. More particularly, a status notification can notify the user as to the completion or failure of the event processing.

In one application, the system 100 is utilized by a system administrator in a production environment. The administrator can open one of the tasks 108A, which according to a particular embodiment contains a list of production sites that are remote from a site at which the at least one processor 102 is located. The initiating event is the administrator's selection of a particular site from the list. The event results in the brokering module 104 passing a message to other sites where tasks B, C associated with the other applications 108B, 108C are located, each residing on a distinct computing device such as a server. The message is passed to the remotely located tasks B, C, the message containing task context and/or data for updating the tasks. The tasks B, C are updated and launched (as described below, if a task is closed, it can be updated before or after being launched). The brokering module 104 subsequently causes a notification of each of the tasks B, C to be conveyed to the administrator through the I/O interface 106.

More generally, the disparate applications 108A, 108B, 108C can be installed on a common user-interface (UI) framework. The UI framework can comprise multiple Web sites. When the UI framework comprises multiple Web sites, the brokering module 104 can be implemented with a browser plug-in. Though, not programmed to be aware of one another, the brokering module 104 registers the applications 10A, 10B, 108C and thus can mediate between the application so as to make each aware of the others. Working on a task A can involve launching the other tasks B, C as the tasks are mediating by the brokering module 104. Task context can be passed to the tasks B, C. The tasks can be open, closed or comprise html fragments on a page. Processing based upon the passed context occurs in the background as the other task A runs as the current task.

An open task processes an event in the background, is updated with task context, and a status notification corresponding to the task is provided. A closed task processes, based on an event, the task context passed to the it, and is loaded along with a status notification. The status notification can indicate that the associated tasks have successfully completed or failed during event processing. The status notification, for example, can comprise a message, visual symbol, or audio signal such as “web site page not loaded,” “web page loaded but process failed,” or the like.

Closed tasks can process an event and then be loaded, or alternatively, can be loaded and then process the event. Html fragments can be on a current page or any other page. The brokering module 104 provides a mechanism whereby events are passed to any html fragment. If the html fragment is on the same current page, the page is partially updated. If the html fragment is in an open task, the open task is partially updated in the background. Because updates are be performed in the background, a user is free to concentrate on other tasks. The user can switch from working with one task to another task when notified by the brokering module 104 that updating of the latter task is complete. Moreover, because an event can be sent to multiple tasks at or near the same time, the user can receive an update pertaining to all interdependent tasks.

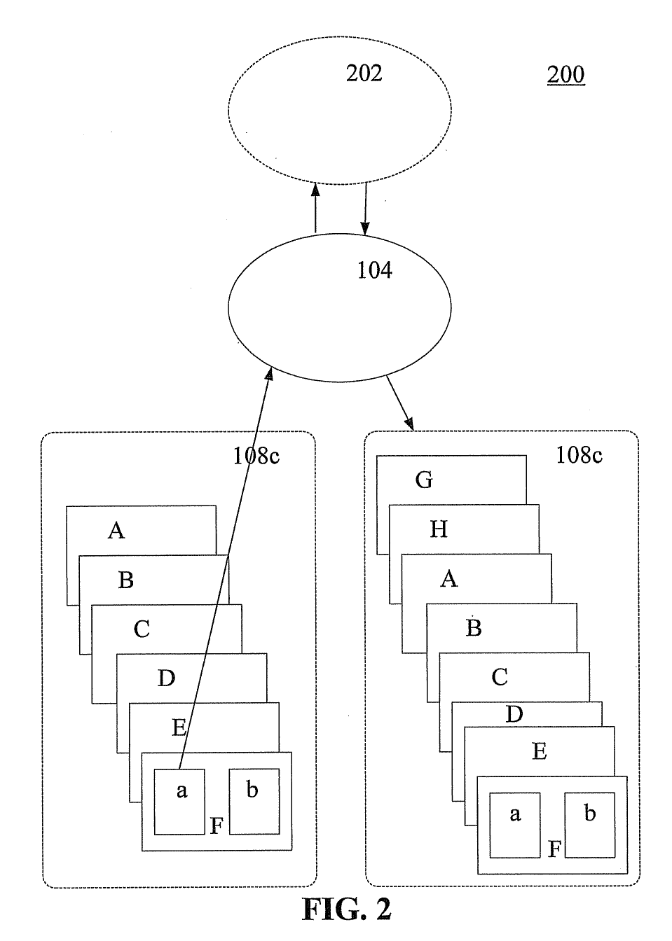

Referring additionally now to FIG. 2, certain of these operative features 200 of the system 100 are schematically illustrated. Initially, a user working an html fragment “b” contained in a task F that is one of several tasks A-F of applications residing on one or more computing devices, such as a device utilizing a multitask browser, causes an event. The event is passed to open tasks A, E, to another html fragment “a”, and to closed tasks G, H. Optionally the brokering module 104 can communicate with a network-connected server 202 to obtain new tasks as needed. The open tasks process the event and are updated in the background. Task F is partially refreshed. The html fragment “a” is refreshed. Tasks G, H are loaded and events processed. The processing occurs in the background as a user is working from html fragment “b” in task F. A corresponding status notification can be proved as described above.

As already noted, the tasks can be provided by different independent applications. Each task is registered with the brokering module 104 and can be capable of generating events. The events can be client events, ones processed on the client side, or the events can be server-side events, that are processed on a server. A system administrator or browser user can create event routing configurations. When an event is generated, it is conveyed to the brokering module 104. The brokering module 104 evaluates the event and associated routing information as well as analyzes the interdependency among the different tasks. In the context of a network environment, such as the Internet or other network, the brokering module 104 can send the event to loaded client-side tasks. Once the event is processed, if needed the brokering module 104 retrieves the updated html fragment from the server and updates the DOM.

For tasks not loaded on the client side, the brokering module 104 can retrieve tasks from a server and, depending on the configuration, process the event before loading the task or after loading the task. In either event, the brokering module 104 can ultimately add tasks to the Document Object Model (DOM), a platform-independent, language-neutral object model for representing HTML, XML and/or related formats which can be modified by programs and/or scripts.

If an event is sent to an html fragment, the brokering module 104 can determine the location of the html fragment. The fragment can be on the same currently-running task or any other task in the multi-task environment. The brokering module 104 can pass the event to the fragment and update the DOM with the updated html fragment. Once the DOM is updated with the latest updated tasks, the brokering module 104 can provide status indicators indicating the status of each of the tasks. A status indicator can comprise a providing color-coded tabs, wherein a particular color indicates a particular status. Other visual symbols indicating status can be utilized. In other embodiments, audible notifications of status can be provided.

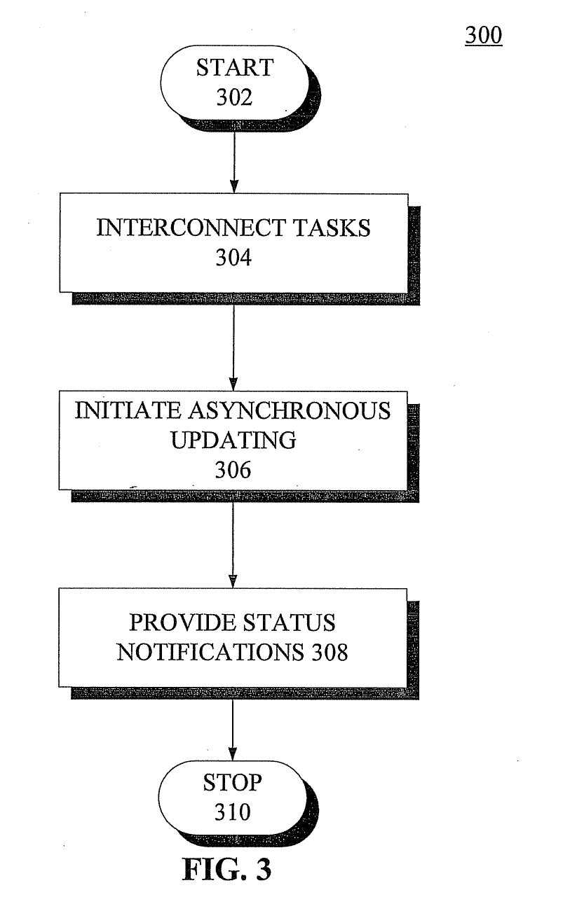

FIG. 3 is a flowchart of exemplary steps in a method 300 for updating interdependent tasks in a multi-task environment, according to another embodiment. The method 300 illustratively includes, after the start at step 302, interconnecting a plurality of event-responsive interdependent tasks in response to an event generated while one of the tasks is being processed, wherein the tasks are provided by different applications, at step 304. The method continues at step 306 by initiating an asynchronous updating of the tasks, wherein the asynchronous updating comprises a background process of the multi-task environment preformed for each task not being currently processed and wherein the updating is performed while the one task is being processed. The method 300 further includes providing to a user a status notification of the updating of each of the tasks at step 308. The method 300 illustratively concludes at step 310.

According to a particular embodiment of the method 300, interconnecting the tasks comprises evaluating the event, determining routing information, and/or analyzing interdependency among the tasks. The method 300 can further include updating the tasks based upon a message, text context, and/or data.

According to another embodiment, initiating asynchronous updating comprises passing to at least one task, other than the one being processed, a message containing task context and/or data. The at least one other task can be an open task, a closed task, and/or an html fragment of a page.

According to still another embodiment, providing a status notification comprises generating at visual symbol, a color-coded tab, and/or audible indicator. The indicator indicates to a user the status of a particular task corresponding to the indicator.

In yet another embodiment, the method 300 further comprises registering each of the tasks with a broker. Additionally, according to another embodiment, processing one task can result in the launching of at least one other task. The various tasks, according to still another embodiment of the method 300 can be mediated by the broker.

According to another embodiment, the method 300 can further include updating one or more of the plurality of tasks, other than the one task being processed, the at least one other task comprising a closed task, and subsequently loading the at least one other task to a processor for processing the task. Alternatively updating one or more tasks can comprise loading to a processor at least one other of the plurality of tasks, other than the one task being processed, the at least one other task comprising a closed task, and subsequently updating the at least one other task.

The invention, as also already noted, can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing description of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

We claim:

1. A computer-implemented method for updating interdependent tasks in a multi-task environment, the method comprising:
interconnecting a plurality of event-responsive interdependent tasks in response to an event generated while one of the tasks is being processed, wherein the tasks are provided by different applications;
initiating an asynchronous updating of the tasks, wherein the asynchronous updating comprises a background process of the multi-task environment preformed for each task not being currently processed and wherein the updating is performed while the one task is being processed; and
providing to a user a status notification of the updating of each of the tasks.

2. The method of claim 1, wherein interconnecting the tasks comprises at least one among evaluating the event, determining routing information, and analyzing interdependency among the tasks.

3. The method of claim 1, further comprising updating the tasks based upon at least one among a message, text context, and data.

4. The method of claim 1, wherein initiating asynchronous updating comprises passing to at least one task other than the one being processed a message containing at least one among task context and data, the at least one other task comprising at least one among an open task, a closed task, and an html fragment of a page.

5. The method of claim 1, wherein providing a status notification comprises generating at least one among a visual symbol, a color-coded tab, and audible indicator.

6. The method of claim 1, further comprising registering each of the tasks with a broker.

7. The method of claim 6, wherein processing of the one task comprises launching at least one other of the plurality of tasks.

8. The method of claim 7, further comprising mediating the one task and at least one launched task.

9. The method of claim 1, further comprising updating at least one other of the plurality of tasks other than the one task being processed, the at least one other task comprising a closed task, and subsequently loading the at least one other task to a processor for processing the task.

10. The method of claim 1, further comprising loading to a processor at least one other of the plurality of tasks other than the one task being processed, the at least one other task comprising a closed task, and subsequently updating the at least one other task.

11. A computer-based system for updating interdependent tasks in a multi-task environment, the system comprising:
at least one processor for processing processor-executable code;
an input/output interface communicatively linked to the at least one processor; and
a brokering module configured to execute on the at least one processor, the brokering module further configured to
interconnect a plurality of event-responsive interdependent tasks in response to an event generated while one of the tasks is being processed, wherein the tasks are provided by different applications,
initiate an asynchronous updating of the tasks, wherein the asynchronous updating comprises a background process of the multi-task environment preformed for each task not being currently processed and wherein the updating is performed while the one task is being processed, and
provide through the interface a status notification of the updating of each of the tasks.

12. The system of claim 11, wherein the brokering module is configured to interconnect the tasks by performing at least one among evaluating the event, determining routing information, and analyzing interdependency among the tasks.

13. The system of claim 11, wherein the brokering module is configured to update the tasks based upon at least one among a message, text context, and data.

14. The system of claim 11, wherein the brokering module is configured to initiate asynchronous updating by passing a message to at least one task other than one being processed, the message containing at least one among task context and data and the at least one other task comprising one among an open task, a closed task, and an html fragment of a page.

15. The method of claim 11, wherein the status notification comprises at least one among a visual symbol, a color-coded tab, and audible indicator.

16. A computer-readable storage medium in which is embedded computer-readable code that when loaded to and executed by a computer updates one or more interdependent tasks in a multi-task environment by:
interconnecting a plurality of event-responsive interdependent tasks in response to an event generated while one of the tasks is being processed, wherein the tasks are provided by different applications;
initiating an asynchronous updating of the tasks, wherein the asynchronous updating comprises a background process of the multi-task environment preformed for each task not being currently processed and wherein the updating is performed while the one task is being processed; and
providing to a user a status notification of the updating of each of the tasks.

17. The computer-readable storage medium of claim 16, wherein the computer-readable code is configured to cause the computer to interconnect the tasks by performing at least one among evaluating the event, determining routing information, and analyzing interdependency among the tasks.

18. The computer-readable storage medium of claim 16, wherein the computer-readable code further comprise code for causing the computer to update the tasks based upon at least one among a message, text context, and data.

19. The computer-readable storage medium of claim 16, wherein the computer-readable code for causing the computer to initiate asynchronous updating comprises code for causing the computer to pass to at least one task other than the one being processed a message containing at least one among task context and data, the at least one other task comprising at least one among an open task, a closed task, and an html fragment of a page.

20. The computer-readable storage medium of claim 16, wherein the computer-readable code for causing the computer to provide a status notification comprises code for causing the computer to generate at least one among a visual symbol, a color-coded tab, and audible indicator.
